(19) United States
(12) Patent Application Publication
(10) Pub. No.: US 2026/0119585 A1
(43) Pub. Date: Apr. 30, 2026

(54) ML-Based Selection Of Components Of A Graphical User Interface Based On User-Defined Queries

(71) Applicant: Oracle International Corporation, Redwood Shores, CA (US)

(72) Inventor: Jennifer Darmour, Seattle, WA (US)

(73) Assignee: Oracle International Corporation, Redwood Shores, CA (US)

(21) Appl. No.: 19/324,791

(22) Filed: Sep. 10, 2025

Related U.S. Application Data
(60) Provisional application No. 63/712,901, filed on Oct. 28, 2024.

(51) Int. Cl. G06F 16/9038; G06F 16/903

(52) U.S. Cl. CPC G06F 16/9038; G06F 16/90335

(57) ABSTRACT

Techniques for information to present to a user in response to a data type of a query result for a query received from the user are disclosed. The system executes the user provided query to generate the query result. Based on (a) the first data type of the query result and/or (b) characteristics of the user, the system selects a second data type and determines one or more values corresponding to the second data type that are not responsive to the first query. The system concurrently presents the query result corresponding to the first data type and the set of one or more values corresponding to the second data type.

### INCORPORATION BY REFERENCE; DISCLAIMER

Each of the following applications are hereby incorporated by reference: application No. 63/712,901 filed on Oct. 28, 2024. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to the use of artificial intelligence to aid in decision making. In particular, the present disclosure relates to determining information to present to a user in response to a data type of a query result.

### BACKGROUND

Artificial intelligence (AI) assistants, including health assistants, are virtual tools (e.g., chatbots or voice assistants), that interact with users, such as clinicians and patients, to provide information, guidance, or task automation. In healthcare, AI health assistants support clinicians and patients by answering health-related questions, offering reminders, analyzing symptoms, or guiding care decisions.

Beyond healthcare, AI assistants are widely used across non-medical domains, serving a variety of roles. In customer service, AI assistants handle inquiries, process returns, and troubleshoot issues across different industries, like banking, retail, and telecom. In education, AI tutors provide personalized instruction, quiz generation, and academic support based on student progress and learning style. In enterprise productivity, AI assistants schedule meetings, summarize emails, generate reports, or automate routine workflows. In e-commerce, AI assistants offer product recommendations, support virtual try-ons, and help with order tracking and checkout. In smart homes, voice-based assistants control devices, play media, and respond to contextual commands.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1A shows a block diagram illustrating a machine learning engine in accordance with one or more embodiments;

FIG. 1B illustrates a machine learning engine in accordance with one or more embodiments;

FIG. 2 illustrates an example set of operations of the machine learning engine of FIG. 1B;

FIG. 3 illustrates an example set of operations for determining information to be presented to a user responsive to a data type of a query results in accordance with one or more embodiments;

FIG. 4 illustrates an example set of operations for selecting components to display in a graphical user interface based on user-defined queries in accordance with one or more embodiments;

FIGS. 5A-5D illustrate screenshots of an example operations of an AI assistant in accordance with one or more embodiments; and

FIG. 6 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. AI ASSISTANT SYSTEM ARCHITECTURE
3. MACHINE LEARNING ARCHITECTURE
4. MACHINE LEARNING ENGINE OPERATION
5. GENERATIVE MODELS
6. DETERMINING INFORMATION TO PRESENT TO A USER RESPONSIVE TO A DATA TYPE OF A QUERY RESULT
7. SELECTING COMPONENTS TO DISPLAY TO A USER BASED ON A USER QUERY AND DATA SETS RELEVANT TO THE USER QUERY
8. EXAMPLE INTERFACES OF AN AI ASSISTANT
9. PRACTICAL APPLICATION; IMPROVEMENTS & ADVANTAGES
10. HARDWARE OVERVIEW
11. MISCELLANEOUS; EXTENSIONS

### 1. General Overview

One or more embodiments determine information to present to a user in response to a data type of a query result for a query received from the user. The system executes the user provided query to generate the query result. Based on (a) the first data type of the query result and/or (b) characteristics of the user, the system selects a second data type and determines one or more values corresponding to the second data type that are not responsive to the first query. The system concurrently presents the query result corresponding to the first data type and the set of one or more values corresponding to the second data type.

One or more embodiments apply a machine learning (ML) model to select a template from a candidate set of templates for presenting information in response to receiving a query. The ML model is applied to feature vectors that represent (a) the query, (b) the query results, and/or (c) characteristics of a requesting user. The information presented in response to receiving the query includes (a) results of the query and (b) information related to the query results that is neither part of the query results nor responsive to the query. The information related to the query results is dependent on the template selected by the ML model. Different templates may reference different sets of information and/or include different arrangements of sets of information.

As an example, if a template selected by the ML model includes a placeholder for a chart or graph, the system populates the template with a chart or graph that is related to the query results. The chart or graph is separate from the query results for a query and is not requested by the query. If the template selected by the ML model includes a placeholder for a textual representation of a patient's medical history, then the system populates the template with a textual representation of a patient's medical history. The patient's medical history is separate from the query results for a query and is not requested by the query. In an embodiment, the system submits the template selected by the ML model and/or placeholders within the selected template to a generative AI model to generate/obtain content for populating the template. Accordingly, the output of the template selection ML model may be submitted as input to a generative AI model.

One or more embodiments described in this Specification and/or recited in the claims may not be included in this General Overview section.

### 2. AI Assistant System Architecture

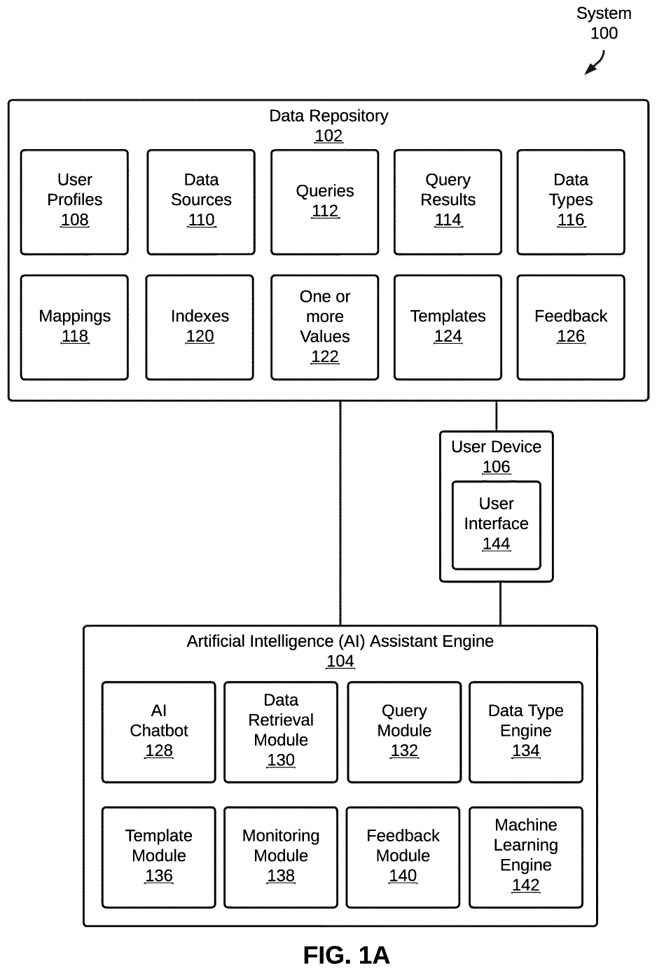

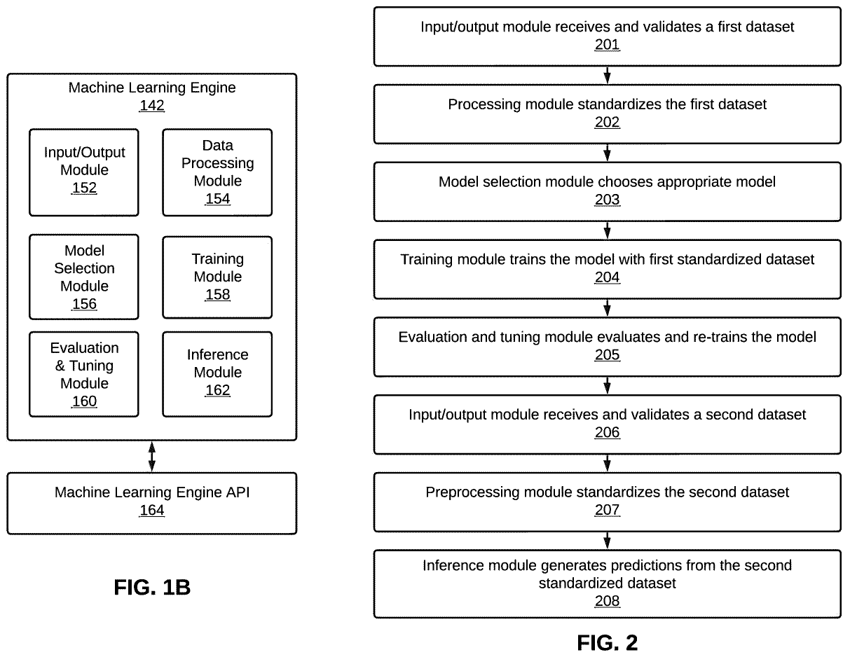

FIG. 1 illustrates an AI assistant system 100 in accordance with one or more embodiments. As illustrated in FIG. 1, system 100 includes a data repository 102, an AI assistant engine 104, and a user device 106. In one or more embodiments, system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In one or more embodiments, data repository 102 is any type of storage unit and/or device (e.g., a file system, database, collection of tables, or any other storage mechanism) for storing data. Furthermore, data repository 102 may include multiple different storage units and/or devices. The multiple different storage units and/or devices may or may not be of the same type or located at the same physical site. Furthermore, data repository 102 may be implemented or executed on the same computing system as AI assistant engine 104. Additionally, or alternatively, data repository 102 may be implemented or executed on a computing system separate from AI assistant engine 104. Data repository 102 may be communicatively coupled to AI assistant 104 via a direct connection or via a network.

Information describing how to determine information to present to a user responsive to a data type of a query result may be implemented across any of components within the system 100. However, this information is illustrated within the data repository 102 for purposes of clarity and explanation.

In one or more embodiments, data repository 102 includes user profiles 108, one or more data sources 110, queries 112, query results 114, data types 116, mappings 118, indexes 120, values 122, templates 124, and feedback 126.

In one or more embodiments, user profiles 108 refer to sets of key-value pairs, flags, and/or linked data structures that describe user-specific attributes. User-specific attributes may include role, e.g., physician, nurse, patient, administrator; specialty or domain focus, e.g., cardiology, endocrinology; access level or permissions, e.g., read/write privileges, PHI access; interaction history, e.g., previous queries, accessed data types; preferences, e.g., preferred units, display language; and/or organizational context, e.g., facility ID, department affiliation. Each user profile may be instantiated as a unique record within a user registry and stored in a relational database, directory service, or graph-based identity system.

In one or more embodiments, data sources 110 refer to sources of data that store and provide access to structured and unstructured data across multiple domains. Each data source may include a standalone system, module, service endpoint, database instance, data warehouse, or external interface capable of supplying data to AI assistant engine 104. Data sources 110 may include clinical data repositories, operational data systems, external knowledge sources, user profile data sources, telemetry or monitoring feeds, and/or natural language repositories. Clinical data repositories may include electronic health record (EHR) systems that include patient observations, diagnoses, medications, procedures, lab results, and encounter histories. Operational data systems may include hospital scheduling, staffing, or billing systems. External knowledge sources may include clinical ontologies, medical literature databases, or guideline repositories. User profile data sources maintain records of user roles, specialties, access permissions, and interaction history. Telemetry and/or monitoring feeds may include real-time patient vitals, wearable device data, and/or equipment logs. Natural language repositories may include clinical notes, radiology reports, and other unstructured narrative data.

In one or more embodiments, queries 112 refer to requests for information that may pertain to one or more data items stored in one or more data sources 110. Queries 112 refer to an input submitted by a user to initiate the retrieval or generation of information relevant to a domain-specific task or informational goal. Queries 112 may include structured queries, unstructured queries, and/or hybrid queries. Structured queries may include SQL statements, parameterized API calls (e.g., HL7 FHIR), or machine-readable forms with explicitly defined fields and constraints. Unstructured queries may include natural language utterances or text-based prompts. Hybrid queries may combine structured and unstructured components or be formulated by selecting predefined options within a user interface (e.g., dropdowns, filters).

In one or more embodiments, query results 114 refer to data structures, value sets, or content objects generated by executing a user query against one or more data sources 110 and identifying one or more values 122 that satisfy the constraints or criteria specified in the query. Query results 114 may take a form of scalar values (e.g., a single lab result or measurement); records or rows including multiple fields (e.g., medication name, dose, route, and timing); collections or arrays of values (e.g., a time-series trend of systolic blood pressure readings); a textual documents (e.g., a clinical note or diagnostic report); and/or coded objects, mapped to standard terminologies, such as SNOMED CT, LOINC, RxNorm, or ICD-10.

In one or more embodiments, data types 116 refer to semantic and structural categorizations of data that inform how the data is interpreted, processed, related to other data, and presented to a user. Each data element stored or retrieved by AI assistant engine 104 is associated with a corresponding data type. Data types 116 may be derived from database schemas, metadata annotations, terminology systems, ontological mappings, or inferred dynamically based on the format and context of the data. Data types 116 may include quantitative data types, categorical data types, coded data types, temporal data types, narrative or unstructured data types, Boolean data types, and/or relational or linked data types. Quantitative data types may include numerical measurements, optionally associated with units of measure (e.g., weight in kilograms, blood pressure in mmHg). Categorical data types may include discrete classifications or labels (e.g., gender, blood type, risk level). Coded data types may include standardized values mapped to external terminologies (e.g., LOINC, SNOMED CT, ICD-10, RxNorm). Temporal data types may include timestamps, date ranges, durations (e.g., admission date, observation time). Narrative or unstructured data types may include free-text clinical notes, reports, or user-entered descriptions. Boolean data types may include binary indicators (e.g., true/false, present/absent). Relational or linked data types may include entities linked across domains (e.g., encounter-provider relationships, patient-medication associations).

In one or more embodiments, mappings 118 refer to defined relationships between a first item and a second item, where the two items may differ in format, schema, identifier, terminology, or semantic level. Mappings 118 may include Code System Mappings, Schema Mappings, Ontology Mappings, User Profile Mappings, Data Type Mappings. Code system mappings may include relationships between equivalent or related concepts across standard terminologies (e.g., mapping a proprietary diagnosis code to a SNOMED CT concept or mapping LOINC test codes to FHIR Observations). Schema mappings may include associations between fields in heterogeneous data sources (e.g., mapping weight_kg in one database to body_mass in another). Ontology mappings may include logical or hierarchical relationships between concepts in one or more controlled vocabularies or knowledge graphs (e.g., subclass, equivalence, related-to). User profile mappings may include relationships between user characteristics and data preferences or relevance weights (e.g., mapping a clinician's specialty to preferred data types). Data type mappings may include links between different data types to inform context-aware data presentation (e.g., mapping a quantitative glucose result to a related medication list).

In one or more embodiments, mapping 118 may be represented as a tuple, key-value pair, rule, and/or graph edge. Mapping 118 may include metadata, such as source and target identifiers, mapping type (e.g., exact match, approximate match, derived-from), confidence score or weight, source of truth (e.g., manual curation, external terminology service, machine learning inference), and/or applicability constraints (e.g., user role, data context). Mappings 118 may be stored in a mapping repository or be accessed via a terminology service or knowledge management engine.

In one or more embodiments, indexes 120 refer to data structures or mechanisms that facilitate the efficient organization, retrieval, filtering, ranking, or association of data items based on predefined keys, features, or semantic attributes. Indexes 120 may include textual or keyword indexes, field-based database indexes, field-based database indexes, semantic indexes, vector indexes, and/or user-specific indexes. Textual or keyword indexes may include various structures, such as inverted indexes used to support full-text search over clinical notes, reports, or unstructured queries. Field-based database indexes may include conventional indexes on relational or document databases that accelerate lookup based on different fields, such as patient_id, observation_type, timestamp, or data_type. Semantic indexes may include data structures that organize concepts or codes (e.g., SNOMED CT, LOINC, ICD-10) for fast lookup, hierarchy traversal, or concept matching based on ontological relationships. Vector indexes may include embedding-based indexes that support similarity search over semantic representations of queries, documents, or user profiles, often using approximate nearest neighbor (ANN) methods. User-specific indexes may include personalized indexes based on user history, preferences, or specialty, allowing fast retrieval of user-relevant content.

In one or more embodiments, one or more values 122 refers to a data structure comprising at least one discrete data item and optionally, a plurality of such items, corresponding to the output of a query or supplemental operation performed by AI assistant engine 104. Values 122 may include scalar values, composite values, narrative or textual values, coded values, and/or contextual metadata. Scalar values, as noted above, may include single data points, such as numerical measurements (e.g., 82.3 kg), coded entries (e.g., ICD-10: E11.9), timestamps, or Boolean flags. Composite values may include structured data objects with multiple fields (e.g., medication name, dose, and route). Narrative or textual values may include unstructured or semi-structured text segments (e.g., clinical notes, symptom descriptions). Coded values may include values mapped to standardized vocabularies or classification systems (e.g., SNOMED CT, LOINC, RxNorm). Contextual metadata may include associated attributes, such as source, unit of measure, time of recording, data quality, or relevance score. Each value may be linked to a specific data type.

In one or more embodiments, templates 124 refer to predefined or dynamically generated structures for formatting, organizing, and visually rendering one or more data values within a user interface 144 of user device 106. Each template may include a layout or design framework. The layout may include placeholders, layout definitions, styling rules, and/or conditional display logic. Placeholders may include named or positional fields within the template configured to receive and display specific types of data (e.g., [PatientName], [Measurement Value], [Timestamp]). Layout definitions may include specifications for how visual elements are arranged (e.g., vertical list, table, card, chart, timeline). Styling rules May include visual characteristics, such as font, color, iconography, or emphasis, used to highlight important information. Conditional display logic may include rules that control the visibility or formatting of data based on value thresholds, user role, or context (e.g., red text for abnormal values). Templates 124 may be maintained in a registry, database, or embedded in configuration files accessible to the assistant runtime. Templates 124 may be stored as reusable definitions and selected or instantiated at runtime based on the data type, the user's role or device, or the nature of the query result.

In one or more embodiments, feedback 126 refers to any input provided by the user after interaction with the AI assistant. The input reflects the user's assessment, preference, correction, or behavioral signal regarding the accuracy, relevance, usability, or presentation of information generated or presented by the assistant. Types of feedback include explicit feedback and/or implicit feedback. Explicit feedback may include user selections (e.g., thumbs-up/down, star ratings, checkbox confirmations), corrections to values (e.g., editing a displayed result), comments or annotations, and direct responses to questions, such as “Was this information helpful?” Implicit feedback may include interaction patterns (e.g., scrolling, time-on-screen, mouse hover), navigation behavior (e.g., clicking into or away from a presented result), query reformulations or follow-up queries, selection of alternate results or actions.

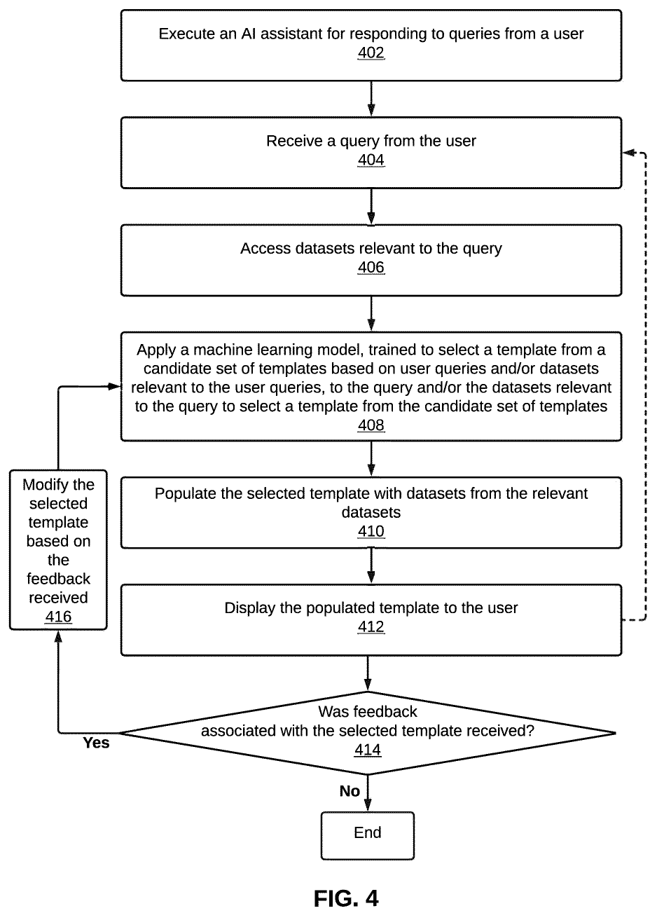

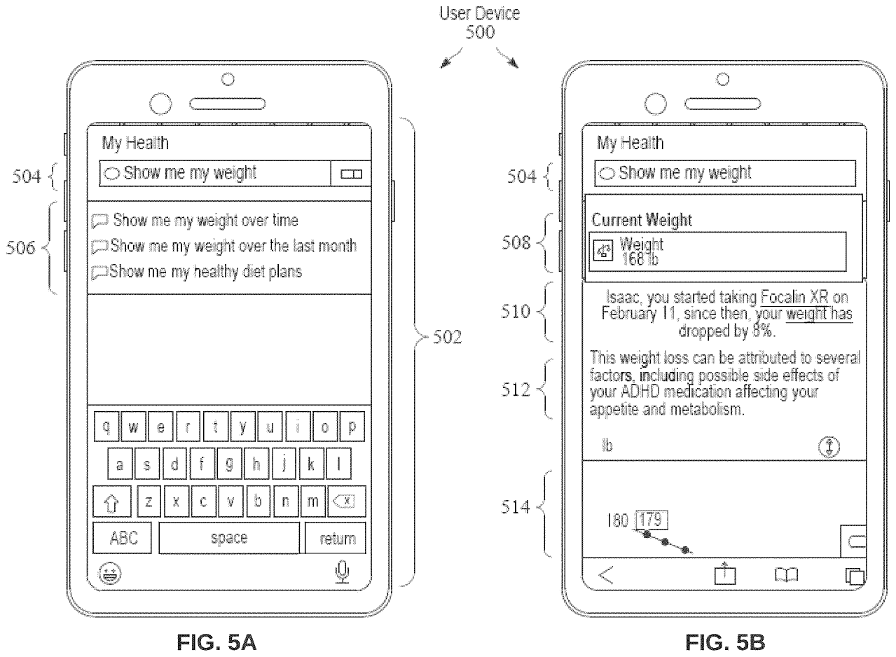

In one or more embodiments, AI assistant engine 104 refers to hardware and/or software configured to perform operations described herein for determining information to present to a user responsive to a data type of a query result. Examples of operations for determining information to present to a user responsive to a data type of a query result are described below with reference to FIGS. 3 and 4.

In an embodiment, AI assistant engine 104 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, AI assistant engine 104 includes an AI chatbot 128. AI chatbot 128 refers to hardware and/or software configured to perform operations described herein for receiving queries or other input from users and generating corresponding responses. AI chatbot 128 may use generative AI, large language models (LLM), or other generative models to facilitate interactive, dialog-based communication between the user and the AI assistant engine 104. A detailed description of generative AI, LLMs, and other ML models is provided below with reference to FIGS. 3 and 4.

In one or more embodiments, AI assistant engine 104 includes a data retrieval module 130. Data retrieval module 130 refers to hardware and/or software configured to perform operations described herein identifying, accessing, and/or retrieving relevant data from one or more data sources 110 in response to user queries, system-generated instructions, or context-aware logic executed by AI assistant engine 104.

In one or more embodiments, AI assistant engine 104 includes a query module 132. Query module 132 refers to hardware and/or software configured to perform operations described herein for receiving, interpreting, and/or transforming user inputs or system-generated instructions into one or more structured queries for execution against one or more data sources 110. Query module 132 may use generative AI or other ML modules to provide suggested queries based on user input.

In one or more embodiments, AI assistant engine 104 includes a data type engine 134. Data type engine 134 refers to hardware and/or software configured to perform operations described herein for identifying, prioritizing, and/or selecting one or more data types for the purpose of information retrieval and display. The data types may be relevant to a user query, user profile, or system context.

In one or more embodiments, AI assistant engine 104 includes a template module 136. Template module 136 refers to hardware and/or software configured to perform operations described herein for selecting, populating, rendering, and/or modifying one or more templates 124. Template module 136 may modify one or more templates in response to feedback received by feedback module 140.

In one or more embodiments, AI assistant engine 104 includes a monitoring module 138. Monitoring module 138 refers to hardware and/or software configured to perform operations described herein for observing, tracking, or/and analyzing behavior, performance, interactions, and/or outputs of AI assistant engine 104 in real time or near-real time. Monitoring module 138 enables continuous oversight of AI assistant operations to ensure reliability, correctness, responsiveness, security, and contextual appropriateness.

In one or more embodiments, AI assistant engine 104 includes a feedback module 140. Feedback module 140 refers to hardware and/or software configured to perform operations described herein for receiving, interpreting, recording, and/or applying user-provided or system-detected feedback in connection with responses, behaviors, outputs, or interactions of AI assistant engine 104. Feedback module 140 enables adaptive refinement and continuous learning within AI assistant engine 104.

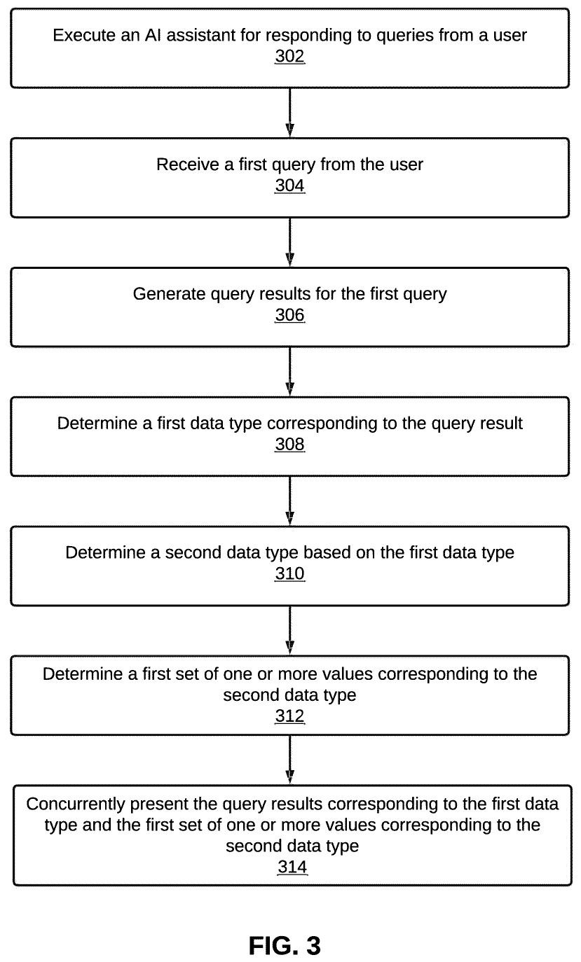

In one or more embodiments, AI assistant engine 104 includes an ML engine 142. ML engine 142 refers to hardware and/or software configured to perform the operations described herein for training and applying machine learning models. The structure and function of ML engine 142 will be described below in detail with reference to FIGS. 1B and 2.

In one or more embodiments, user device 106 includes a user interface 144. User interface 144 refers to hardware and/or software configured to facilitate communications between a user and AI assistant engine 104. User interface 144 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of user interface 144 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, user interface 144 is specified in one or more other languages, such as Java, C, or C++.

### 3. Machine Learning Architecture

FIG. 1B illustrates a machine learning engine 142 in accordance with one or more embodiments. As illustrated in FIG. 1B, machine learning engine 142 includes input/output module 152, data preprocessing module 154, model selection module 156, training module 158, evaluation and tuning module 160, and inference module 162.

In accordance with an embodiment, input/output module 152 serves as the primary interface for data entering and exiting the system, managing the flow and integrity of data. This module may accommodate a wide range of data sources and formats to facilitate integration and communication within the machine learning architecture.

In an embodiment, an input handler within input/output module 152 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 152 to be versatile in different operational contexts, whether processing historical datasets or streaming data.

In accordance with an embodiment, input/output module 152 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 152 includes an output framework designed to handle the distribution and exportation of outputs, predictions, or insights. Using the output framework, input/output module 152 formats these outputs into user-friendly and accessible formats, such as reports, visualizations, or data files compatible with other systems. Input/output module 152 also ensures secure and efficient transmission of these outputs to end-users or other systems in an embodiment and may employ encryption and secure data transfer protocols to maintain data confidentiality.

In accordance with an embodiment, data preprocessing module 154 transforms data into a format suitable for use by other modules in machine learning engine 142. For example, data preprocessing module 154 may transform raw data into a normalized or standardized format suitable for training ML models and for processing new data inputs for inference. In an embodiment, data preprocessing module 154 acts as a bridge between the raw data sources and the analytical capabilities of machine learning engine 142.

In an embodiment, data preprocessing module 154 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 154 may be configured to handle anomalies in different ways depending on context. Data preprocessing module 154 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 154 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 154 processes new data for inference, data preprocessing module 154 replicates the same preprocessing steps to ensure consistency with the training data format. This helps to avoid discrepancies between the training data format and the inference data format, thereby reducing the likelihood of inaccurate or invalid model predictions.

In an embodiment, model selection module 156 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 156 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 156 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 156 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The MSE metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 156 also considers computational efficiency and resource constraints. This is meant to help ensure the selected model is both accurate and practical in terms of computational and time requirements. In an embodiment, certain features of model selection module 156 are configurable such as a configured bias toward (or against) computational efficiency.

In accordance with an embodiment, training module 158 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 158 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 158 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 158 includes logic to handle different types of data and learning tasks. For instance, it includes different training routines for supervised learning (where the training data comes with labels) and unsupervised learning (without labeled data). In the case of deep learning models, training module 158 also manages the complexities of training neural networks that include initializing network weights, choosing activation functions, and setting up neural network layers.

In an embodiment, evaluation and tuning module 160 incorporates dynamic feedback mechanisms and facilitates continuous model evolution to help ensure the system's relevance and accuracy as the data landscape changes. Evaluation and tuning module 160 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 160 performs continuous model tuning by using hyperparameter optimization. Evaluation and tuning module 160 performs an exploration of the hyperparameter space using algorithms, such as grid search, random search, or more sophisticated methods like Bayesian optimization. Evaluation and tuning module 160 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 160 integrates data feedback and updates the model. Evaluation and tuning module 160 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 160 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 160 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 162 transforms data raw data into actionable, precise, and contextually relevant predictions. In addition to processing and applying a trained model to new data, inference module 162 may also include post-processing logic that refines the raw outputs of the model into meaningful insights.

In an embodiment, inference module 162 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 162 transforms the outputs of a trained model into definitive classifications. Inference module 162 employs the underlying model as a tool to generate probabilistic outputs for each potential class. It then engages in an interpretative process to convert these probabilities into concrete class labels.

In an embodiment, when inference module 162 receives the probabilistic outputs from the model, it analyzes these probabilities to determine how they are distributed across some or every potential class. If the highest probability is not significantly greater than the others, inference module 162 may determine that there is ambiguity or interpret this as a lack of confidence displayed by the model.

In an embodiment, inference module 162 uses thresholding techniques for applications where making a definitive decision based on the highest probability might not suffice due to the critical nature of the decision. In such cases, inference module 162 assesses if the highest probability surpasses a certain confidence threshold that is predetermined based on the specific requirements of the application. If the probabilities do not meet this threshold, inference module 162 may flag the result as uncertain or defer the decision to a human expert. Inference module 162 dynamically adjusts the decision thresholds based on the sensitivity and specificity requirements of the application, subject to calibration for balancing the trade-offs between false positives and false negatives.

In accordance with an embodiment, inference module 162 contextualizes the probability distribution against the backdrop of the specific application. This involves a comparative analysis, especially in instances where multiple classes have similar probability scores, to deduce the most plausible classification. In an embodiment, inference module 162 may incorporate additional decision-making rules or contextual information to guide this analysis, ensuring that the classification aligns with the practical and contextual nuances of the application.

In regression models, where the outputs are continuous values, inference module 162 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 162 incorporates domain-specific adjustments into its post-processing routine. This involves tailoring the model's output to align with specific industry knowledge or contextual information. For example, in financial forecasting, inference module 162 may adjust predictions based on current market trends, economic indicators, or recent significant events, ensuring that the outputs are both statistically accurate and practically relevant.

In an embodiment, inference module 162 includes logic to handle uncertainty and ambiguity in the model's predictions. In cases where inference module 162 outputs a measure of uncertainty, such as in Bayesian inference models, inference module 162 interprets these uncertainty measures by converting probabilistic distributions or confidence intervals into a format that can be easily understood and acted upon. This provides users with both a prediction and an insight into the confidence level of that prediction. In an embodiment, inference module 162 includes mechanisms for involving human oversight or integrating the instance into a feedback loop for subsequent analysis and model refinement.

In an embodiment, inference module 162 formats the final predictions for end-user consumption. Predictions are converted into visualizations, user-friendly reports, or interactive interfaces. In some systems, like recommendation engines, inference module 162 also integrates feedback mechanisms, where user responses to the predictions are used to continually refine and improve the model, creating a dynamic, self-improving system.

### 4. Machine Learning Engine Operation

FIG. 2 illustrates the operation of a machine learning engine in one or more embodiments. In an embodiment, input/output module 152 receives a dataset intended for training (Operation 201). This data can originate from diverse sources, like databases or real-time data streams, and in varied formats, such as CSV, JSON, or XML. Input/output module 152 assesses and validates the data, ensuring its integrity by checking for consistency, data ranges, and types.

In an embodiment, training data is passed to data preprocessing module 154. Here, the data undergoes a series of transformations to standardize and clean it, making it suitable for training ML models (Operation 202). This involves normalizing numerical data, encoding categorical variables, and handling missing values through techniques like imputation.

In an embodiment, prepared data from the data preprocessing module 154 is then fed into model selection module 156 (Operation 203). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 158 trains the selected model with the prepared dataset (Operation 204). It implements learning algorithms to adjust the model's internal parameters, optimizing them to identify patterns and relationships in the training data. Training module 158 also addresses the challenge of overfitting by implementing techniques, like regularization and early stopping, ensuring the model's generalizability.

In an embodiment, evaluation and tuning module 160 evaluates the trained model's performance using the validation dataset (Operation 205). Evaluation and tuning module 160 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 152 receives a dataset intended for inference. Input/output module 152 assesses and validates the data (Operation 206).

In an embodiment, data preprocessing module 154 receives the validated dataset intended for inference (Operation 207). Data preprocessing module 154 ensures that the data format used in training is replicated for the new inference data, maintaining consistency and accuracy for the model's predictions.

In an embodiment, inference module 162 processes the new data set intended for inference, using the trained and tuned model (Operation 208). It applies the model to this data, generating raw probabilistic outputs for predictions. Inference module 162 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 164 allows for applications to leverage machine learning engine 142. In an embodiment, machine learning engine API 164 may be built on a RESTful architecture and offer stateless interactions over standard HTTP/HTTPS protocols. Machine learning engine API 164 may feature a variety of endpoints, each tailored to a specific function within machine learning engine 142. In an embodiment, endpoints such as/submitData facilitate the submission of new data for processing, while/retrieveResults is designed for fetching the outcomes of data analysis or model predictions. The MLE API may also include endpoints like/updateModel for model modifications and/trainModel to initiate training with new datasets.

In an embodiment, machine learning engine API 164 is equipped to support SOAP-based interactions. This extension involves defining a WSDL (Web Services Description Language) document that outlines the API's operations and the structure of request and response messages. In an embodiment, machine learning engine API 164 supports various data formats and communication styles. In an embodiment, machine learning engine API 164 endpoints may handle requests in JSON format or any other suitable format. For example, machine learning engine API 164 may process XML, and it may also be engineered to handle more compact and efficient data formats, such as Protocol Buffers or Avro, for use in bandwidth-limited scenarios.

In an embodiment, machine learning engine API 164 is designed to integrate WebSocket technology for applications necessitating real-time data processing and immediate feedback. This integration enables a continuous, bi-directional communication channel for a dynamic and interactive data exchange between the application and machine learning engine 142.

### 5. Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a LLM. LLMs are designed to understand, generate, and interpret human language by processing extensive collections of data. The foundational architecture behind LLMs is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 152, when used for LLMs, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 154 in the context of LLMs may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 156, when used for LLMs involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 158, when used for LLMs, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 160 assesses the performance of LLMs using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 162, in the context of LLMs, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides LLMs and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond LLMs.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 6. Determining Information to Present to a User Responsive to a Data Type of a Query Result

FIG. 3 illustrates an example set of operations for determining information to present to a user responsive to a data type of a query result in accordance with one or more embodiments. One or more operations illustrated in FIG. 3 may be modified, rearranged, or omitted. Accordingly, the particular sequence of operations illustrated in FIG. 3 should not be construed as limiting the scope of one or more embodiments.

One or more embodiments execute an AI assistant for responding to queries from a user (Operation 302). The AI assistant uses AI, ML, and natural language processing (NLP) to respond to queries from a user. The user may be an employee, a patient, a client, a business professional, a clinician, a healthcare provider, or other interested person. The AI assistant may be executed through various interfaces including mobile apps, voice assistants, or messaging platforms. Using the AI assistant may require verification of user credentials to ensure privacy and maintain confidential information.

One or more embodiments receive a first query from the user (Operation 304). The user may enter the query in a chat interface or provide the query through a voice assistant, e.g., Alexa or Google Assistant. The query may be in natural language form, e.g., typed or spoken, in a structured form, e.g., filtered form inputs or dropdowns, and/or semi-structured prompts, e.g., template-based request. The query may relate to inventory, equipment, scheduling, logistics, expenses. In a healthcare context, the query may relate to symptoms, medications, mental health, chronic conditions, or other medical conditions, concerns, and observations.

In one or more embodiments, the system receives the query from the user and applies a natural language understanding module or rule-based parser to extract query intent and entities and map the query intent to a corresponding first data type. The mapping may rely on a semantic model, data schema, or ontology, enabling the assistant to recognize that the requested data type corresponds to structured numerical values (e.g., systolic and diastolic blood pressure measurements). The system may then invoke a query module construct a structured query (e.g., SQL, FHIR REST API call, or NoSQL query) that targets a data field or collection associated with the identified first data type. The query module may apply relevant filters, such as time constraints, user context, or source identifiers. The query module may format the query to retrieve values, metadata, and supporting context (e.g., measurement units, timestamps, reference ranges).

One or more embodiments generate query results for the first query (Operation 306). The system submits the constructed query to a data retrieval module. The data retrieval module may execute the query against one or more target data sources, including clinical repositories, enterprise databases, or external services. The data retrieval module may handle authentication, access control, and source-specific data formats. The data retrieval module may retrieve one or more values that satisfy the query conditions and correspond to the first data type. The query result may include structured output such as a list of numeric observations with associated metadata (e.g., {“heart_rate”: 84, “unit”: “bpm”, “recorded_at”: “2025-06-24T14: 31:00Z”}).

One or more embodiments, determine a first data type corresponding to the query results (Operation 308). To determine the first data type, the system may use one or more of a source schema metadata lookup, ontology or vocabulary mapping, machine learning-based classification, statistical analysis of value patterns, field name or label heuristics, provenance and context inference, user profile or prior interaction history, and/or template or presentation hints.

When using a source schema metadata lookup to determine the first data type, the system may reference the data schema, API specification, or metadata of the source field or table that returned the result. For example, if the result came from a column labeled bp_systolic with a type INTEGER, the system infers a quantitative data type.

When using ontology or vocabulary mapping to determine the first data type, the system may map the returned value (or field) to a known ontology, terminology, or controlled vocabulary (e.g., SNOMED CT, LOINC, RxNorm). For example, if a value maps to a SNOMED concept with semantic tag clinical finding, the system may infer that the data type is likely a coded clinical. When using a machine learning-based classification, the system uses a trained ML model to classify the result (or its context) into one of several known data types. The system may use value patterns, e.g., decimal, string, code-like tokens; field name embeddings, or source provenance. For example, a model may determine that {“value”: “Metroprolol”, “dose”: “50 mg”} represents medication data.

When using statistical analysis of value patterns to determine the first data type, the system may analyze statistical properties of the result set. This may include value distributions, data density, outliers and/or temporal spacing or sequencing. For example, the system may classify a dense time series with numerical values as quantitative trend data.

When using field name or label heuristics to determine the first data type, the system may use pattern matching or lookup tables based on known field labels, headings, or keys. For example, the system may identify fields named “weight”, “height”, “temperature” as quantitative data types.

When using provenance and context inference to determine the first data type, the system may consider the source system or module (e.g., vitals monitor, medication prescribing app) or the query context (e.g., follow-up to a trend question). For example, data returned from a cardiology device is likely to include time-series metrics.

When using user profile or prior interaction history to determine the first data type, if the same user frequently accesses specific data types, or if the session context involves a known workflow (e.g., discharge planning), the system may weight certain data types more heavily. For example, if a user regularly reviews lab panels, the system may preemptively classify ambiguous numeric fields as lab-related.

When using template or presentation hints to determine the first data type, the system may attempt to match the result to a template or UI component, and infer the data type based on what the template expects. For example, a matched “time-series chart” template suggests the data is temporal and quantitative.

One or more embodiments determine a second data type based on the first data type (Operation 310). Once the first data type is determined from the query result, the system may determine a second data type related to and different from the first data type using one or more of ontology-based association, knowledge graph traversal, historical query pattern mining, workflow or role-based mapping, statistical correlation across records, redefined clinical or business rules, embedding similarity, time-series or event progression analysis, and/or template or report co-occurrence.

When using ontology-based association to determine the second data type, the system may use domain-specific ontologies (e.g., SNOMED CT, LOINC, UMLS) to identify conceptually or hierarchically related entities. For example, from a first data type of “blood glucose (quantitative)”, the system may infer that related second data types include “insulin dosage (medication)” or “HbAlc (lab value)”.

When using knowledge graph traversal to determine the second data type, the system may traverse edges in a knowledge graph where nodes represent data types or concepts and edges represent meaningful relationships (e.g., causes, measuredBy, co-occursWith). For example, from “systolic blood pressure”, the system may traverse to “antihypertensive drugs”, then to “medication adherence”.

When using historical query pattern mining to determine the second data type, the system may analyze historical user behavior (e.g., sequential query logs) to identify data types that frequently follow or co-occur with the first data type. For example, the system may observe that users who query “ejection fraction” next ask about “heart failure diagnoses”→second data type: ICD-10 code group for CHF.

When using workflow or role-base mapping to determine the second data type, the system may use the user's workflow stage (e.g., assessment, treatment planning) or role (e.g., nurse vs. physician) to determine what data types logically follow the first. For example, for a discharge nurse viewing “current medications”, the system may determine that next data type may be “medication education provided”; for a pharmacist, it may be “renal dosing parameters”.

When using statistical correlation across records to determine the second data type, the system may perform statistical analysis across datasets to find features that frequently co-vary or cluster with the first data type. For example, the system may determine that high ALT (liver enzyme) is statistically associated with “hepatotoxic drug use” and “hepatitis diagnosis”.

When using predefined clinical or business rules to determine the second data type, the system may use rule sets (manually authored or extracted) that define common data dependencies. For example, the system may apply a rule that “If first data type=HbA1c AND value>8.0→recommend retrieving diabetes management plan (second data type)”.

When using embedding similarity, i.e., vector space inference to determine the second data type, the system may use vector embeddings of data type labels or sample values to compute semantic similarity between types. For example, the system may determine that “Weight” and “BMI” have high embedding cosine similarity and, therefore, are considered related types.

When using time-series or event progression analysis to determine the second data type, in temporal datasets, the system may look at what data types typically precede or follow the current one in clinical or business time. For example, after elevated troponin values (first data type), the next types expected by the system may include ECG results or discharge diagnoses

When using template or report co-occurrence to determine the second data type, the system may analyze structured reports or dashboards to identify data types that routinely appear together. For example, in metabolic panels, glucose is often shown alongside sodium and creatinine.

One or more embodiments, determine a first set of one or more values corresponding to the second data type (Operation 312). The system constructs a second query targeting the second data type. The data retrieval module executes the second query to obtain a first set of one or more values corresponding to the second data type. These values may be retrieved from structured databases, clinical repositories, and/or semantic indexes or document stores. The result may include one or more relevant items (e.g., medications, procedures, lab results) that were not explicitly requested by the user but are contextually inferred based on the previously retrieved first data type.

In one or more embodiments, the system receives, detect, or otherwise identify a request for a dataset corresponding to a third data type. The request may be explicitly submitted by a user, e.g., “What medications is the patient currently taking?”, implied from conversational context, e.g., a follow-up like “What are the side effects?” after viewing lab results, and/or system-generated, based on predefined rules or recommendation algorithms that determine additional data would be helpful for decision support. The request for additional data may originate from multiple input channels, including natural language, structured form elements, voice input, or API calls. The request is handled in a same or similar manner as the first query described above.

One or more embodiments concurrently present the query results corresponding to the first data type and the first set of one or more values corresponding to the second data type (Operation 314). A template module formats the query result for the first data type and the first set of one or more values corresponding to the second data type for simultaneous or adjacent presentation. Formatting may include assigning visual containers (e.g., cards, panels, tables) for each result type, aligning headers, labels, or timestamps for clarity, and/or applying layout rules that prioritize readability, clinical relevance, or user configuration. Templates may be selected or dynamically adapted based on the combination of data types being presented.

In one or more embodiments, the system generates a composite view that displays the primary result set (first data type) in one region and the secondary result set (second data type) in another region within the same interface or user interaction step. The concurrent presentation may occur in a GUI panel, as part of a chat-based AI assistant response, and/or in a dashboard or structured report view. Optional features may include interactivity (e.g., click to expand, sort, drill-down) or semantic linking (e.g., highlight medications related to specific abnormal values).

### 7. Selecting Components to Display to a User Based on a User Query and Data Sets Relevant to the User Query

FIG. 4 illustrates an example set of operations for selecting components to display to a user based on a user query and datasets relevant to the user query in accordance with one or more embodiments. One or more operations illustrated in FIG. 4 may be modified, rearranged, or omitted. Accordingly, the particular sequence of operations illustrated in FIG. 4 should not be construed as limiting the scope of one or more embodiments.

One or more embodiments execute an AI assistant for responding to queries from a user (Operation 402). The AI assistant uses AI, ML, and/or NLP to respond to queries from a user. The user may be an employee, a patient, a client, a business professional, a clinician, a healthcare provider, or other interested person. The AI assistant may be executed through various interfaces including mobile apps, voice assistants, or messaging platforms.

One or more embodiments receive a query from the user (Operation 404). The user may enter the query in a chat interface or provide the query through a voice assistant, e.g., Alexa or Google Assistant. The query may relate to symptoms, medications, mental health, chronic condition, or other medical conditions, concerns, and observations.

One or more embodiments access datasets relevant to the query (Operation 406). Datasets relevant to the query may be accessed from various sources, including, for example, drug and medication databases, websites, EHRs, and public health and disease registries. Datasets may be retrieved through direct download. The dataset may be provided as CSV, Excel, or JSON files. Datasets may be retrieved using search engines and/or APIs. Datasets may be retrieved from cloud repositories. Datasets may also be retrieved from personal trackers and other monitoring devices.

One or more embodiments apply a machine learning model, trained to select a template from a candidate set of templates based on user queries and/or datasets relevant to the user queries, to the query and/or the datasets relevant to the query to select a template from the candidate set of templates (Operation 408). The system applies the trained ML model to the queries and/or datasets to select a template for displaying the results of the query. Techniques, such as text vectorization, may be used to prepare the query and relevant datasets for use by the ML model. The query and relevant datasets are processed in the same manner as the data used to train the ML model, e.g., normalization, handling missing values. The system may use similarity analysis, e.g., cosine similarity, to select the template for displaying datasets that are most like the relevant datasets.

In one or more embodiments, the candidate set of templates includes various components formatted and arranged to support a user in understanding results of the query. In this manner, the templates are provided for aiding the user in clinical decision making. Components provided in a template may include tables, charts, photographs, videos, audio, illustrations, animations, details, definitions, links to additional information, recommendations, suggested tasks, reminders, trackers, and insights. The charts may provide correlations between conditions, medications, treatments, and the like. Recommendations may include summaries of lab results that incorporate doctor notes and diagnoses. The components may include an option for tracking or monitoring conditions, e.g., blood pressure, weight. The system may provide a warning or other indication when the condition changes or exceeds a threshold.

In one or more embodiments, the templates are customized to preferences of the user. For example, a user may prefer graphs over charts, or a user may be color blind and unable to distinguish between certain colors. The templates may be customized for a user's education and/or level of knowledge. Templates for clinicians or other healthcare professionals may be different for patients or clinicians having different specialties. Templates may be customized based on age, gender, or geographic location. Recommendations, e.g., treatment options, may vary depending on where the user is located. Templates may be modified to account for religious preferences.

One or more embodiments populate the selected template with datasets from the relevant datasets (Operation 410). Initially, the system identifies the data from the relevant datasets necessary for populating the selected template. The selected template may include placeholders used as dynamic components with pre-defined structures. Placeholders allow the template to be populated based on real-time data or AI generated content. Placeholders may include charts, graphs, and textual representation of a patient's medical history. The system formats the patient data in accordance with the structure of the placeholders. Formatting the data may include creating lists, tables, or structure text. The formatted data may then be populated into the selected template.

In one or more embodiments, the system submits the template selected by the ML model and/or submits placeholders within the selected template to a generative AI model to generate or access content for populating the template. Generative AI determines the datasets needed for each of the placeholders. The datasets for populating the placeholders may be accessed from the EHR of the patient and/or other sources.

One or more embodiments display the populated template to the user (Operation 412). The populated selected template may be displayed on a visual interface, e.g., dashboard, for viewing by the user. Dashboards present key metrics, data, or insights in an easily understandable format. Dashboards are configured to provide a real-time overview of relevant information. In addition to providing results to a query, the dashboard may include charts, graphs, tables, gauges, and links to additional information and tools, e.g., task scheduling tools, communication tools. The dashboard may include interactive graphics, audio and/or video, photographs, and animations. Dashboards may be configured for viewing on mobile devices. In embodiments, the components are arranged longitudinally to permit scrolling between vertically between components. Alternatively, the components may be on separate pages that are shuffled through using a horizontal motion.

One or more embodiments receive feedback associated with the selected template (Operation 414). Feedback may be provided in any number of ways. The generated response using the selected template may request user provided feedback directly. This may include a rating system, e.g., 1 to 5 stars, open-ended comments, and quick polls, e.g., thumbs up or down. Feedback may be gathered through user interactions. For example, the user may interact with a graph, i.e., select or zoom in on the graph, for further viewing. Scrolling past a chart without sufficient time to view material of the chart may be received as feedback that the user did not view the chart. Following a link provided in the display may be received as feedback that the information provided was determined by the user to be useful. When no feedback is received, the operations end.

In one or more embodiments, the user provides an additional request or follow-up query. The system processes the follow-up query in the same manner as the original query. Datasets relevant to the follow-up query are accessed. The follow-up query and relevant datasets may be combined with the original query and relevant datasets. The ML model may then be applied to the combined queries and relevant datasets to determine a template best suited for displaying the results of the combined queries and relevant datasets.

In one or more embodiments, additional requests and/or follow-up queries are used by the system as feedback. More particularly, the system may use follow-up queries to anticipate future queries by the same or other users. The system may modify the template to anticipate the follow-up query and provide the information in response to the original query.

One or more embodiments modify the selected template based on the feedback received (Operation 416). Modifying the selected template may include adding components or eliminating components. Modifying the selected template may include rearranging the presentation of the components. Modifying the selected template may include changing the type of component presented in the template, e.g., table v chart. The selected template may be modified for the particular user, for a category of users, or for users of a particular type, e.g., clinician, patient. The modified template may then be used to further retrain the machine learning model for future use.

### 8. Example Interfaces of an AI Assistant

A detailed example is described below for purposes of clarity. Components and/or operations described below should be understood as one specific example that may not be applicable to certain embodiments. Accordingly, components and/or operations described below should not be construed as limiting the scope of any of the claims.

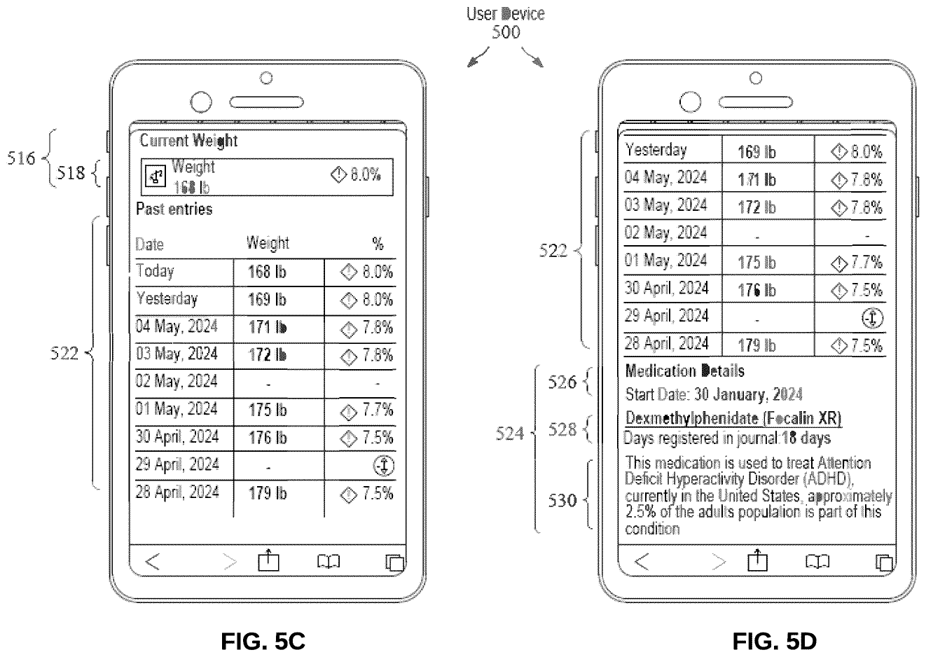

FIGS. 5A-5D illustrate a user interaction with an AI assistant according to one or more embodiments. As relates to FIGS. 5A-5D, a patient interacts with an AI assistant through a user interface 502 on a user device 500, e.g., smartphone. The user may access the AI assistant using one or more authentication or verification mechanisms to ensure data security and privacy. The AI assistant provides the user with immediate access to the latest patient information.

With particular reference to FIG. 5A, as the user enters a query into a text box 504 of user interface 502, the AI assistant may offer suggested queries 506. As shown, the user entered the query, “Show me my weight,” into text box 504. The AI assistant offers suggested queries 506, including “Show me my weight over time”, “Show me my weight over the last month”, and “Show me my healthy diet plans”. The AI assistant may generate suggested queries 506 using generative AI or LLMs or other ML models. The system may use the user profile to tailor suggested queries 506 to user preferences and/or user history.

Turning to FIG. 5B, in response to receiving the patient query, “Show me my weight”, the AI assistant generates a component 508 that includes a label, i.e., “Current Weight”, a quantitative value for the user weight, i.e., 168 lbs, and may optionally include an icon, symbol or other visual item. Component 508 responds directly to the user query and includes a first data type.

In addition to providing the user with a response to the patient query, the AI assistant provides a first set of information 510, a second set of information 512, and a third set of information 514. First, second, and third sets of information 510, 512, 514 relate to the patient query and are not requested by the query. As shown, the first set of information 510 includes identification of a medication that may affect the patient's weight. The first set of information 510 identifies the medication, when the patient began taking the medication, and a percentage of weight loss since taking the medication. The second set of information 512 identifies effects of taking the medication. Although shown in natural language, either or both of the first and second sets of information 510 and 512 may be shown in a structured form, e.g., graph, table, chart. Third set of information 514 includes a graph (partially shown), indicating a starting weight and weights over a period of time.

With reference to FIGS. 5C and 5D, a fourth set of information 516 includes a current weight 518 and an indication of a percentage of weight loss since beginning the medication. A fifth set of information 522 includes a table entitled “Past entries”. The table lists the dates that the patient's weight was recorded, the weight recorded, and the percentage loss since beginning the medication. A fifth set of information 524 includes information related to the medication. Medication details include a start date 526, days registered in journal 528, and a related facts 530.

Each of the first, second, third, fourth, and fifth sets of information 510, 512, 514, 516, 522 correspond to a data type different from a data type of the query result, i.e., user weight. The data types for each of the first, second, third, fourth, and fifth sets of information 510, 512, 514, 516, 522 may be the same or different.

### 9. Practical Application; Improvements & Advantages

In one or more embodiments, AI assistants that determine information to present to a user in response to a data type of a query result wherein the information includes both direct results and contextually relevant but not explicitly requested data offer practical applications, improvements, and advantages over conventional decision support tools.

In the healthcare domain, practical applications of the above disclosed AI assistants include enhancing chart review by surfacing clinically relevant but non-requested data (e.g., medications affecting vitals) and suggesting adjacent or influencing data (e.g., lab results+medications that alter those results). In an example, when a user asks about weight, the AI assistant may also show related lifestyle interventions or medications. In the E-commerce domain, shopping AI assistants may suggest matching accessories or care products when a user searches for shoes. AI assistants may offer post-purchase support; for example, when a user checks delivery status, the assistant may show warranty registration info or reorder suggestions. In the finance domain, banking assistants, when asked about a current balance, may also show unusual spending or upcoming payments. Questioning an investment assistant about stock performance may trigger suggestions for portfolio risk analysis or diversification tools. In enterprise productivity, digital workspace assistants may suggests prep documents or meeting history when asked for a meetings schedule. With project tools, a query about task progress may return information showing risks, deadlines, or dependent tasks.

AI assistants described above offer improvements over conventional systems. Unlike conventional systems that respond strictly to an input query, the present AI assistants enrich responses with related but unrequested insights. Conventional systems require multiple queries to attain deeper context, whereas the present AI assistants deliver multi-dimensional data in one interaction. Conventional systems do not adapt to user type or role. Unlike conventional query systems that provide a static interaction, the present systems provide a dynamic and anticipatory user interface that enhances user experience. Conventional query systems do not offer the same cross-domain reasoning provided by the present systems.

### 10. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

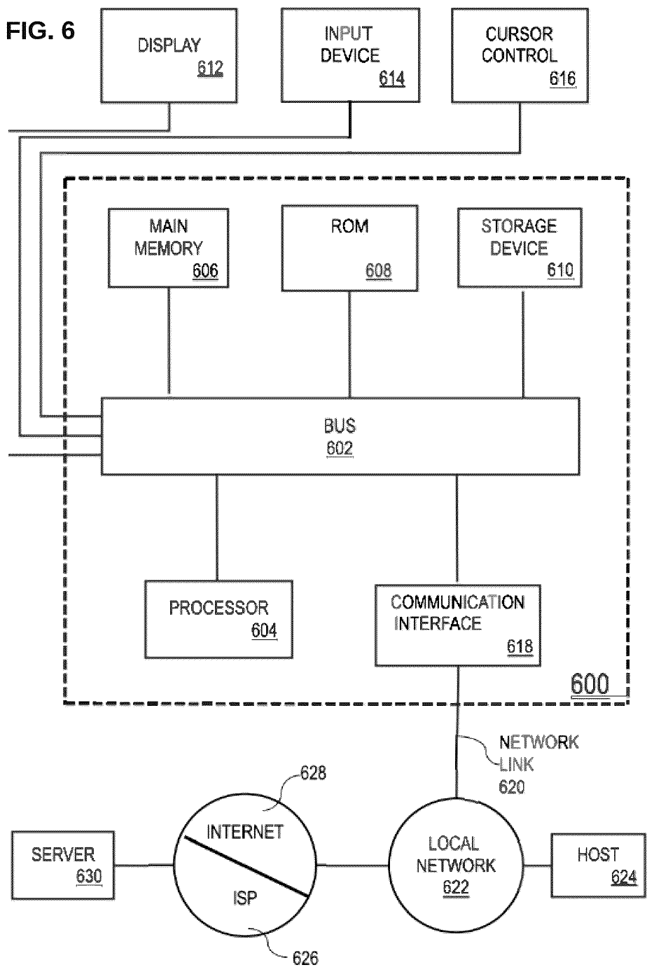

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read-only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 11. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
receiving a first query from a user;
executing the first query to generate a query result corresponding to a first data type;
based on at least one of the query result or characteristics of the user, selecting a second data type that is different than the first data type;
determining a set of one or more values, corresponding to the second data type, that are not responsive to the first query; and
concurrently presenting the query result corresponding to the first data type and the set of one or more values corresponding to the second data type.

2. The method of claim 1, wherein the second data type is selected based on the first data type corresponding to the query result.

3. The method of claim 1, wherein the second data type is selected based on a particular value included in the query result.

4. The method of claim 1, further comprising:
based on at least one of the query result and characteristics of the user: selecting a template of a plurality of templates for displaying the query result;
wherein the template comprises the second data type, and wherein selecting the template comprises selecting the second data type.

5. The method of claim 4, further comprising:
receiving user input comprising a request for a dataset corresponding to a third data type;
responsive to receiving the user input, selecting a fourth data type based on the dataset and/or the third data type; and
concurrently displaying the dataset corresponding to the third data type and at least one value corresponding to the fourth data type.

6. The method of claim 1, further comprising:
obtaining a training dataset comprising the first data type and the second data type;
based on the training dataset, training an ML model to select the second data type in response to at least one of:
receiving a request for data corresponding to the first data type, or detecting query results corresponding to the first data type,
wherein the selecting the second data type comprises applying the ML model to the first data type for the ML model to output the second data type.

7. The method of claim 1, wherein selecting the second data type comprises executing a query to determine that values of the second data type influence values of the first data type.

8. One or more non-transitory computer readable media comprising instructions which, when executed by one or more hardware processors, cause performance of operations comprising:
receiving a first query from a user;
executing the first query to generate a query result corresponding to a first data type;
based on at least one of the query result or characteristics of the user, selecting a second data type that is different than the first data type;
determining a set of one or more values, corresponding to the second data type, that are not responsive to the first query;
concurrently presenting the query result corresponding to the first data type and the set of one or more values corresponding to the second data type.

9. The one or more non-transitory computer readable media of claim 8, wherein the second data type is selected based on the first data type corresponding to the query result.

10. The one or more non-transitory computer readable media of claim 8, wherein the second data type is selected based on a particular value included in the query result.

11. The one or more non-transitory computer readable media of claim 8, wherein the operations further comprise:
based on at least one of the query result and characteristics of the user: selecting a template of a plurality of templates for displaying the query result;
wherein the template comprises the second data type, and wherein selecting the template comprises selecting the second data type.

12. The one or more non-transitory computer readable media of claim 11, wherein the operations further comprise:
receiving user input comprising a request for a dataset corresponding to a third data type;
responsive to receiving the user input, selecting a fourth data type based on the dataset and/or the third data type; and
concurrently displaying the dataset corresponding to the third data type and at least one value corresponding to the fourth data type.

13. The one or more non-transitory computer readable media of claim 8, wherein the operations further comprise:
obtaining a training dataset comprising the first data type and the second data type;
based on the training dataset, training an ML model to select the second data type in response to at least one of:
receiving a request for data corresponding to the first data type, or detecting query results corresponding to the first data type,
wherein the selecting the second data type comprises applying the ML model to the first data type for the ML model to output the second data type.

14. The one or more non-transitory computer readable media of claim 8, wherein selecting the second data type comprises executing a query to determine that values of the second data type influence values of the first data type.

15. A system comprising:
at least one device including a hardware processor;
the system being configured to perform operations comprising:
receiving a first query from a user;
executing the first query to generate a query result corresponding to a first data type;
based on at least one of the query result or characteristics of the user, selecting a second data type that is different than the first data type;
determining a set of one or more values, corresponding to the second data type, that are not responsive to the first query; and
concurrently presenting the query result corresponding to the first data type and the set of one or more values corresponding to the second data type.

16. The system of claim 15, wherein the second data type is selected based on the first data type corresponding to the query result.

17. The system of claim 15, wherein the second data type is selected based on a particular value included in the query result. (actual value in result drives selection of data type of extra info).

18. The system of claim 15, wherein the operations further comprise:
based on at least one of the query result and characteristics of the user: selecting a template of a plurality of templates for displaying the query result;
wherein the template comprises the second data type, and wherein selecting the template comprises selecting the second data type.

19. The system of claim 18, wherein the operations further comprise:
receiving user input comprising a request for a dataset corresponding to a third data type;
responsive to receiving the user input, selecting a fourth data type based on the dataset and/or the third data type; and
concurrently displaying the dataset corresponding to the third data type and at least one value corresponding to the fourth data type.

20. The system of claim 15, wherein the operations further comprise:
obtaining a training dataset comprising the first data type and the second data type;
based on the training dataset, training an ML model to select the second data type in response to at least one of:
receiving a request for data corresponding to the first data type, or detecting query results corresponding to the first data type,
wherein the selecting the second data type comprises applying the ML model to the first data type for the ML model to output the second data type.
